(19) United States
(12) Patent Application Publication
(10) Pub. No.: US 2025/0116804 A1
(43) Pub. Date: Apr. 10, 2025

(54) OPTICAL WAVEGUIDE INCLUDING GRATING TRANSITION AREAS

(71) Applicant: GOOGLE LLC, Mountain View, CA (US)

(72) Inventors: Huihang Dong, Weston, FL (US); Warren Cornelius Welch, III, Longmont, CO (US); Kang Luo, San Jose, CA (US); Wei Jin, Saratoga, CA (US)

(21) Appl. No.: 18/484,024

(22) Filed: Oct. 10, 2023

(51) Int. Cl. F21V 8/00; G02B 26/10; G02B 27/00; G02B 27/01

(52) U.S. Cl. CPC G02B 6/0016; G02B 6/0036; G02B 6/0065; G02B 26/105; G02B 27/0081; G02B 27/0172; G02B 2027/0178

(57) ABSTRACT

A waveguide includes a set of grating structures forming a component on the surface of the waveguide. The set of grating structures is configured to direct light received at the component based on a parameter of one or more grating structures of the set of grating structures. Further, the waveguide includes a first transition area disposed adjacent to a first side of the component wherein the parameter is modulated across the grating structures of the first transition area. Additionally, the waveguide includes a second transition area disposed adjacent to a second, opposite side of the component wherein the parameter is also modulated across the grating structures of the second transition area.

### BACKGROUND

Waveguides, such as those used in head-worn displays (HWDs), are commonly configured to direct light representative of an image from a projector to the eye of a user. To this end, some waveguides include an incoupler and an outcoupler each having sets of grating structures configured to direct light based on various parameters. As an example, within some waveguides, the incoupler of a waveguide is configured to first receive light emitted from a projector and direct the light into the waveguide such that the light propagates through the waveguide toward the outcoupler. After receiving the light, the outcoupler directs the light of the waveguide toward the eye of the user.

To fabricate such waveguides, some systems implement a nanoimprint process that uses a master stamp having patterns representing the sets of gratings for the incouplers and outcouplers of a waveguide. Such a nanoimprint process further includes depositing a material on the master stamp such as an elastomeric polymer and then pressing the material into the patterns of the master stamp. The nanoimprint process then includes removing the material from the master stamp to form a soft working stamp that is used to imprint the grating structures of the incouplers and outcouplers on the surface of a waveguide. However, certain characteristics or parameters for these grating structures increase the likelihood that a soft working stamp introduces deformities in the grating structures when printing them on the surface of a waveguide. For example, certain characteristics or parameters for the grating structures increase the likelihood that a soft working stamp introduces air bubbles in the grating structures. As another example, certain characteristics or parameters for the grating structures increase the chance a soft working stamp is damaged when it is removed from the master stamp. Due to the soft working stamp being damaged, the chance of introducing deformities in the grating structures imprinted by the soft working stamp is increased. Such deformities prevent the grating structures from operating as intended and negatively impact the functionality of the waveguide.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of an example display system housing a laser projector system configured to project images toward the eye of a user using a waveguide with one or more grating transition areas, in accordance with some embodiments.

FIG. 2 is a diagram illustrating a laser projection system that projects images directly onto the eye of a user via laser light, in accordance with some embodiments.

FIG. 3 is a diagram illustrating an example waveguide including an incoupler, outcoupler, exit pupil expansion system, and fiducial markers, in accordance with embodiments.

FIG. 4 is a diagram illustrating an example waveguide including one or more grating transition areas, in accordance with embodiments.

FIG. 5 is a diagram illustrating an example waveguide including first and second grating transition areas having modulated angles, in accordance with embodiments.

FIG. 6 is a diagram illustrating an example waveguide including first and second grating transition areas having modulated depths, in accordance with embodiments.

FIG. 7 is a diagram illustrating an example waveguide including first and second grating transition areas having modulated duty cycles, in accordance with embodiments.

FIG. 8 is a diagram illustrating an example operation for fabricating a soft working stamp representing one or more transition grating areas, in accordance with embodiments.

FIG. 9 is a diagram illustrating a partially transparent view of a head-worn display (HWD) that includes a laser projection system, in accordance with some embodiments

### DETAILED DESCRIPTION

Some head-worn displays (HWDs) (e.g., extended reality HWDs) are configured to direct light toward the eyes of a user such that one or more images are presented to the user. For example, some HWDs have a form resembling eyeglasses and include one or more lenses containing a waveguide to direct light representative of an image to the eye of the user. Herein, the combination of the lens and waveguide is referred to as an “optical combiner,” “optical combiner lens,” or both. Such waveguides, for example, include one or more incouplers, exit pupil expanders (EPEs), and outcouplers configured to direct light from a projector to the eye of the user. As an example, a waveguide includes an incoupler configured to receive light emitted from a projector and direct the received light into the waveguide such that the light propagates through the waveguide using total internal reflection (TIR), partial internal reflection (PIR), or both. The light then propagates through the waveguide until the light is received at an EPE configured to direct the light so as to increase the size of an exit pupil formed by the light. Further, the EPE is configured to direct the lights towards an outcoupler of the waveguide. In response to receiving the light from the EPE, the outcoupler directs the light out of the waveguide and towards the eye of the user such that the light forms an exit pupil representative of an image near the eye of the user. Such an exit pupil, for example, represents the location along the optical path where the beams of the light, as directed by the waveguide, intersect.

To direct light received from a projector, each incoupler, EPE, and outcoupler of the waveguide is formed from a respective set of grating structures. These sets of grating structures, for example, are disposed on a surface of the waveguide and are configured to diffract or reflect light based on the coatings, material, parameters, or any combination thereof of the grating structures within the set of grating structures. That is to say, a set of grating structures is configured to direct light based on one or more parameters, materials, coatings, or any combination thereof of the grating structures within the set of grating structures. Such grating structures include, for example, Bragg grating structures, surface-relief grating structures, polarization volume grating structures, volumetric holographic grating structures, and the like. Additionally, the parameters of these sets of grating structures include, as an example, the shape, the angle, the duty cycle, the width, the depth, the fill factor, or any combination of the grating structures within the set of gratings. As an example, the set of grating structures forming an incoupler includes grating structures having one or more parameters that cause the grating structures to direct received light into the waveguide via reflection or diffraction.

To form these grating structures on the surface of the waveguide, the grating structures are stamped, etched, deposited, or any combination thereof on the surface of the waveguide using lithography (e.g., gray-scale lithography, nanoimprint lithography), etching, trimming (e.g., laser trimming), soft working stamp fabrication, or any combination thereof. As an example, a fabrication process for a waveguide first includes depositing a soft-working stamp material (e.g., elastomeric polymer) on a master stamp that includes a pattern representing one or more sets of gratings to be formed on the surface of a waveguide. The soft-working stamp material is then pressed into the master stamp such that the soft-working stamp material forms a soft-working stamp having a pattern based on the pattern of the master stamp. For example, the soft-working stamp has a pattern that is the negative of the pattern of the master stamp. After the soft-working stamp is formed, the process includes depositing a layer of optical material (e.g., nanoimprint lithography (NIL) ultra-violet (UV) resin, NIL thermal resin) on a substrate such as a glass substrate or plastic substrate that forms a waveguide. The process then includes pressing the soft-working stamp into the optical material to form the sets of grating structures on the surface of the substrate (e.g., waveguide). To help assemble an HWD including such a waveguide, the fabrication process further includes forming one or more sets of grating structures on the surface of the waveguide that represent one or more fiducial markers. Such fiducial markers, for example, each include a set of grating structures and are used to help position the waveguide within the HWD relative to one or more elements of the HWD, such as a lens of an optical combiner. For example, an assembly process includes aligning a waveguide with a lens of an optical combiner using one or more fiducial markers of the waveguide.

However, certain parameters (e.g., angle, depth, duty cycle) for the grating structures within the sets of grating structures increase the likelihood that at least a portion of a soft-working stamp representing such sets of grating structures is damaged during fabrication. For example, a soft-working stamp representing sets of grating structures with certain parameters is likely to stick to the master stamp and rip off when being fabricated, damaging the resulting soft-working stamp. Because a portion of the soft-working stamp is damaged, the likelihood of introducing deformities in the grating structures formed using the soft-working stamp is increased, which negatively impacts the functionality of the waveguide. Additionally, certain parameters for the grating structures within the sets of grating structures increase the likelihood that air bubbles are introduced into the grating structures when the grating structures are formed using a soft-working stamp. Such air bubbles, for example, increase the likelihood that the formed grating structures do not function as intended, also negatively impacting the functionality of the waveguide.

To this end, systems and techniques disclosed herein are directed toward waveguides including one or more grating transition areas. Such grating transition areas, for example, are each disposed adjacent to a first side (e.g., before) of a corresponding incoupler, EPE, outcoupler, or fiducial marker or adjacent to a second side (e.g., after) of a corresponding incoupler, EPE, outcoupler, or fiducial marker. That is to say, one or more sets of grating structures of a waveguide forming a corresponding incoupler, EPE, outcoupler, or fiducial marker each includes a respective grating transition area disposed adjacent to a first side of (e.g., before) the set of grating structures, a respective grating transition area disposed adjacent to a second side of (e.g., after) the set of grating structures, or both. As used herein, a set of grating structures forming a respective incoupler, EPE, outcoupler, or fiducial marker is also referred to as a “main grating area.”

A grating transition area, for example, includes two or more grating structures each having parameters based on a corresponding set of gratings (e.g., the set of gratings disposed next to the grating transition area). For example, a grating transition area includes one or more modulated parameters such that each grating structure of the grating transition area has respective distinct values for each of the modulated parameters based on how close a grating structure is to a set of gratings. As an example, within a grating transition area, a first grating structure farthest from a corresponding main grating area has a first value for a modulated parameter, and a second grating structure closest to the corresponding main grating area has a second value for the modulated parameter. Further, within the grating transition area, each grating structure has a respective value for the modulated parameter that approaches the first value the closer the grating structure is to the first grating structure and that approaches the second value the closer the grating structure is to the second grating structure. In this way, a grating transition area includes a gradient of values for one or more modulated parameters. Due to such a gradient, the parameters for the grating structures change over the length of the grating transition area until they approach the values of the parameters within the main grating area, making the change in such parameters less extreme when compared to a waveguide without the grating transition areas.

Because a waveguide includes these grating transition areas on its surface, the fabrication process for such a waveguide is less likely to introduce deformities when forming the sets of grating structures for the incouplers, EPEs, outcouplers, and fiducial markers of the waveguide. For example, to fabricate such a waveguide, a master stamp having a pattern representing an inverse (i.e., negative) of the grating transition areas and main grating areas is produced. A soft-working stamp material is then pressed into the master stamp to produce a soft-working stamp having a pattern representing the grating transition areas and the main grating areas. Due to the grating transition areas being represented by the master stamp, the soft-working stamp is less likely to stick to the master stamp when being removed, decreasing the likelihood that the soft-working stamp is damaged. Additionally, due to the resulting soft-working stamp also including patterns representing the grating transition areas, the likelihood that air bubbles are introduced into the grating structures formed by the soft-working stamp is also reduced. Because the likelihood of introducing deformities into the sets of grating structures is reduced, the sets of grating structures for the incouplers, EPEs, outcouplers, and fiducial markers of the waveguide are more likely to function as intended, helping improve the functionality of the waveguide.

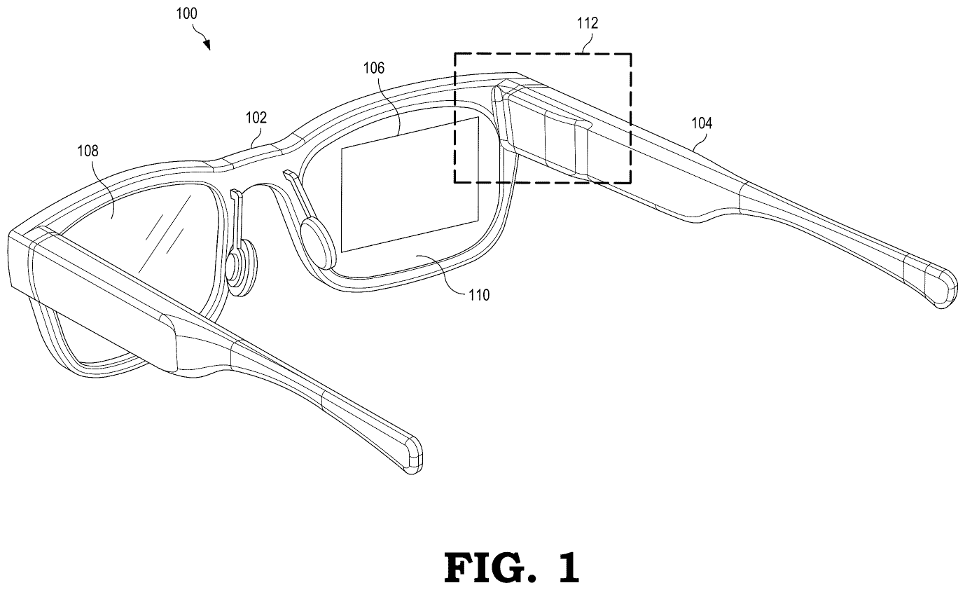

FIG. 1 illustrates an example display system 100 having a support structure 102 that includes an arm 104, which houses a projection system configured to project display light representative of images toward the eye of a user, such that the user perceives the projected images as being displayed in a field of view (FOV) area 106 of a display at one or both of lens elements 108, 110. In the depicted embodiment, the display system 100 is an HWD that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth interface, a Wi-Fi interface, and the like. Further, in some embodiments, the support structure 102 further includes one or more batteries or other portable power sources for supplying power to the electrical components of the display system 100. In some embodiments, some, or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

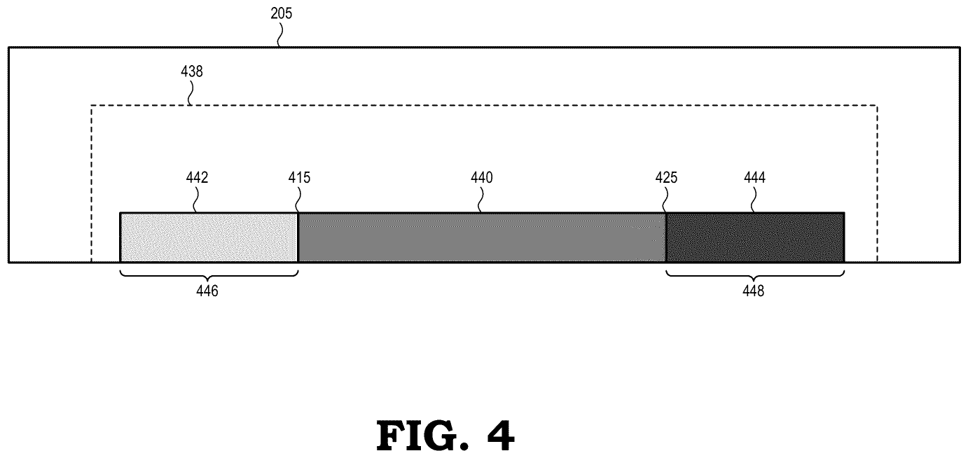

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, display light used to form a perceptible image or series of images may be projected by a projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward the eye of a user of the display system 100. The display light is modulated and scanned onto the eye of the user such that the user perceives the display light as an image. In addition, each of the lens elements 108, 110 is sufficiently transparent to allow a user to see through the lens elements to provide an FOV of the user's real-world environment such that the image appears superimposed over at least a portion of the real-world environment. According to embodiments, the incoupler of the waveguide includes a respective set of grating structures (e.g., main grating area) configured to direct light into the waveguide such that the light propagates through the waveguide using TIR, PIR, or both. Further, the outcoupler of the waveguide includes a respective set of grating structures (e.g., main grating area) configured to direct light out of the waveguide and toward the eye of the user. In embodiments, both the incoupler and outcoupler include a respective grating transition area disposed adjacent to a first side of (e.g., before) the incoupler or outcoupler, a respective grating transition area disposed adjacent to a second side (e.g., after) the incoupler or outcoupler, or both. As discussed below in detail with regards to FIG. 4, each grating transition area includes one or more grating structures having one or more modulated parameters such that each grating structure of the grating transition area has respective values for each modulated parameter. Such parameters, for example, include the shape, the angle, the duty cycle, the width, the depth, the fill factor, or any combination of the grating structures, to name a few.

In some embodiments, the projector is a digital light processing-based projector, a microdisplay, scanning laser projector, or any combination of a modulative light source. For example, according to some embodiments, the projector includes a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be MEMS-based or piezo-based). The projector is communicatively coupled to the controller and a non-transitory processor-readable storage medium or a memory that stores processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106 and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

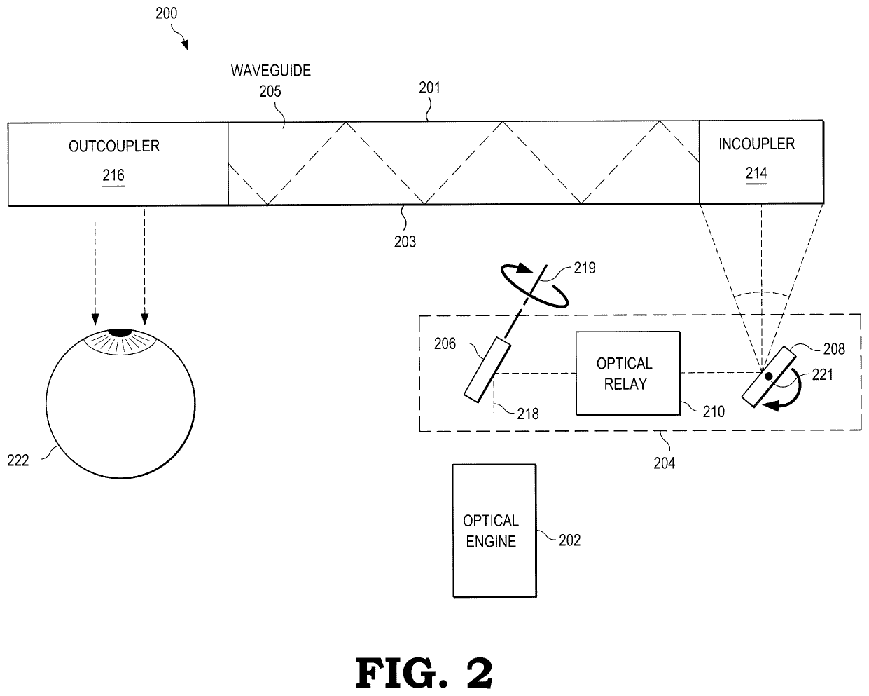

FIG. 2 illustrates a simplified block diagram of a projection system 200 that projects images directly onto the eye of a user via display light. The projection system 200 includes an optical engine 202, an optical scanner 204, and a waveguide 205. The optical scanner 204 includes a first scan mirror 206, a second scan mirror 208, and an optical relay 210. The waveguide 205 has a first major surface 201 and a second, opposing major surface 203. Further, the waveguide 205 includes an incoupler 214 and an outcoupler 216, with the outcoupler 216 being optically aligned with an eye 222 of a user in the present example. In some embodiments, the projection system 200 is implemented in an HMD or other display system, such as the display system 100 of FIG. 1.

The optical engine 202 includes one or more light sources configured to generate and output display light 218 (e.g., visible light such as red, blue, and green light and/or non-visible light such as infrared light). These light sources, for example, include one or more lasers, light emitting diodes (LEDs), organic LEDs (OLEDs), or any combination thereof. In some embodiments, the optical engine 202 is coupled to a driver or other controller (not shown), which controls the timing of emission of light from the light sources of the optical engine 202 in accordance with instructions received by the controller or driver from a computer processor coupled thereto to modulate the display light 218 to be perceived as images when output to the retina of an eye 222 of a user.

For example, during the operation of the projection system 200, multiple display light beams having respectively different wavelengths are output by the light sources of the optical engine 202, then combined via a beam combiner (not shown), before being directed to the eye 222 of the user. As an example, the projection system 200 emits a first display light beam having a first wavelength associated with green light, a second display light beam having a second wavelength associated with red light, and a third display light beam having a third wavelength associated with blue light. The optical engine 202 modulates the respective intensities of the display light beams so that the combined display light reflects a series of pixels of an image, with the particular intensity of each display light beam at any given point in time contributing to the amount of corresponding color content and brightness in the pixel being represented by the combined display light at that time.

One or both of the scan mirrors 206 and 208 of the optical scanner 204 are MEMS mirrors in some embodiments. For example, in some embodiments, the scan mirror 206 and the scan mirror 208 are MEMS mirrors that are driven by respective actuation voltages to oscillate during active operation of the projection system 200, causing the scan mirrors 206 and 208 to scan the display light 218. Oscillation of the scan mirror 206 causes display light 218 output by the optical engine 202 to be scanned through the optical relay 210 and across a surface of the second scan mirror 208. The second scan mirror 208 scans the display light 218 received from the scan mirror 206 toward an incoupler 214 of the waveguide 205. In some embodiments, the scan mirror 206 oscillates along a first scanning axis 219, such that the display light 218 is scanned in only one dimension (e.g., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 214 has a substantially rectangular, circular, or elliptical profile and is configured to receive the display light 218 and direct the display light 218 into the waveguide 205. The incoupler 214 is defined by a smaller dimension (i.e., width) and a larger orthogonal dimension (i.e., length). In an embodiment, the optical relay 210 is a line-scan optical relay that receives the display light 218 scanned in a first dimension by the first scan mirror 206 (e.g., the first dimension corresponding to the small dimension of the incoupler 214), routes the display light 218 to the second scan mirror 208, and introduces a convergence to the display light 218 in the first dimension to an exit pupil beyond the second scan mirror 208. Herein, an “exit pupil” in an optical system refers to the location along the optical path where beams of light intersect. For example, the possible optical paths of the display light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the display light 218 corresponding to that exit pupil. Accordingly, the exit pupil can be considered a “virtual aperture”. According to various embodiments, the optical relay 210 includes one or more collimation lenses that shape and focus the display light 218 on the second scan mirror 208 or includes a molded reflective relay that includes two or more spherical, aspheric, parabolic, and/or freeform lenses that shape and direct the display light 218 onto the second scan mirror 208. The second scan mirror 208 receives the display light 218 and scans the display light 218 in a second dimension, the second dimension corresponding to the long dimension of the incoupler 214 of the waveguide 205. In some embodiments, the second scan mirror 208 causes the exit pupil of the display light 218 to be swept along a line along the second dimension. In some embodiments, the incoupler 214 is positioned at or near the swept line downstream from the second scan mirror 208 such that the second scan mirror 208 scans the display light 218 as a line or row over the incoupler 214.

In some embodiments, the optical engine 202 includes an edge-emitting laser (EEL) that emits a display light 218 having a substantially elliptical, non-circular cross-section, and the optical relay 210 magnifies or minimizes the display light 218 along its semi-major or semi-minor axis to circularize the display light 218 prior to the convergence of the display light 218 on the second scan mirror 208. In some such embodiments, a surface of a mirror plate of the scan mirror 206 is elliptical and non-circular (e.g., similar in shape and size to the cross-sectional area of the display light 218). In other such embodiments, the surface of the mirror plate of the scan mirror 206 is circular.

The waveguide 205 of the laser projection system 200 includes the incoupler 214 and the outcoupler 216. The term “waveguide,” as used herein, will be understood to mean a combiner using one or more of TIR, PIR, specialized filters, and/or reflective surfaces, to transfer light from an incoupler (such as the incoupler 214) to an outcoupler (such as the outcoupler 216). In some display applications, the light is a collimated image, and the waveguide transfers and replicates the collimated image to the eye. In general, the terms “incoupler” and “outcoupler” will be understood to refer to a set of any type of optical grating structures, including, but not limited to, diffraction grating structures, holograms, holographic optical elements (e.g., optical elements using one or more holograms), volume diffraction grating structures, volume holograms, surface relief diffraction grating structures, and/or surface relief holograms. In some embodiments, a given incoupler or outcoupler is configured as a set of transmissive grating structures (e.g., transmissive diffraction grating structures or transmissive holographic grating structures) that causes the incoupler or outcoupler to transmit light and to apply designed optical function(s) to the light during the transmission. In some embodiments, a given incoupler or outcoupler is a set of reflective grating structures (e.g., reflective diffraction grating structures or reflective holographic grating structures) that causes the incoupler or outcoupler to reflect light and to apply designed optical function(s) to the light during the reflection. In embodiments, incoupler 214 and outcoupler 216 each include one or more transition grating areas disposed adjacent to a first side of the incoupler 214 or outcoupler 216, a second, opposite side of the incoupler 214 or outcoupler 216, or both. As explained below in further detail with regards to FIG. 4, such transition grating areas include modulated parameters and are configured to help in the fabrication process of the waveguide 205. For example, the transition grating areas help prevent damage to a soft-working stamp used to form the incoupler 214 and outcoupler 216 on the waveguide 205.

In the present example, the display light 218 received at the incoupler 214 is relayed to the outcoupler 216 via the waveguide 205 using TIR. The display light 218 is then output to the eye 222 of a user via the outcoupler 216. As described above, in some embodiments the waveguide 205 is implemented as part of an eyeglass lens, such as the lens element 108 or lens element 110 (e.g., FIG. 1) of the display system having an eyeglass form factor and employing the projection system 200.

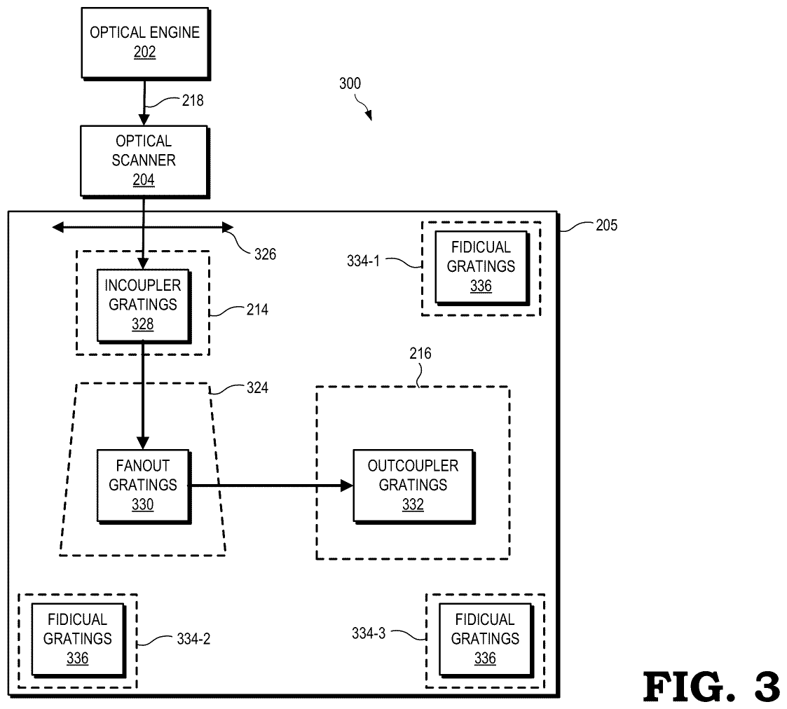

Although not shown in the example of FIG. 2, in some embodiments additional optical components are included in any of the optical paths between the optical engine 202 and the scan mirror 206, between the scan mirror 206 and the optical relay 210, between the optical relay 210 and the scan mirror 208, between the scan mirror 208 and the incoupler 214, between the incoupler 214 and the outcoupler 216, and/or between the outcoupler 216 and the eye 222 (e.g., in order to shape the display light for viewing by the eye 222 of the user). In some embodiments, a prism is used to steer display light from the scan mirror 208 into the incoupler 214 so that display light is coupled into incoupler 214 at the appropriate angle to encourage the propagation of the display light in waveguide 205 by TIR. Also, in some embodiments, an exit pupil expander (EPE) (e.g., EPE 324 of FIG. 3, described below), such as a set of fold grating structures, is arranged in an intermediate stage between incoupler 214 and outcoupler 216 to receive display light that is coupled into waveguide 205 by the incoupler 214, expand the display light, and redirect the display light towards the outcoupler 216, where the outcoupler 216 then couples the display light out of waveguide 205 (e.g., toward the eye 222 of the user). In embodiments, the EPE includes a transition grating area disposed adjacent to a first side of the EPE, a transition grating area disposed adjacent to a second, opposite side of the EPE, or both.

FIG. 3 illustrates a waveguide exit pupil expansion system 300, according to embodiments. In embodiments, waveguide exit pupil expansion system 300 is implemented in, for example, display system 100 and is configured to provide an image to an eye 222 of a user of an HWD. To this end, waveguide exit pupil expansion system 300 includes optical engine 202, optical scanner 204, and waveguide 205. According to embodiments, optical engine 202 is configured to project display light 218 (e.g., light having one or more wavelengths associated with white light, green light, red light, blue light, infrared light, ultraviolet light, or any combination thereof) towards optical scanner 204. In response to receiving display light 218, optical scanner 204 is configured to scan display light 218 along at least a first scanning axis 326, for example, by using one or more scan mirror 206, 208 each configured to oscillate about a respective axis 219, 221. Optical scanner 204 is then configured to provide display light 218 as scanned along at least a first scanning axis 326 to incoupler 214 of waveguide 205.

After receiving display light 218, incoupler 214 is configured to guide display light 218 from incoupler 214 to EPE 324 via at least a portion of waveguide 205. For example, incoupler 214 guides display light 218 from incoupler 214 such that display light 218 propagates through at least a portion of waveguide 205 via TIR, PIR, or both and is received at EPE 324. To this end, incoupler 214 includes one or more incoupler gratings 328 each configured to diffract or reflect display light 218 in one or more directions into a portion of waveguide 205. Such incoupler gratings 328, for example, include a set of grating structures (e.g., Bragg grating structures, surface-relief grating structures, polarization volume grating structures, volumetric holographic grating structures, mirrors, facets, mirror coatings) disposed on a surface of waveguide 205 and configured to diffract or reflect received display light based on one or more parameters of the incoupler gratings 328. Such parameters, for example, include the shape, the angle, the duty cycle, the width, the depth, the fill factor, or any combination of the grating structures of incoupler gratings 328. According to embodiments, the incoupler 214 includes one or more transition grating areas having grating structures with parameters based on the parameters of incoupler gratings 328.

In response to receiving display light 218 from the incoupler 214 (e.g., via at least a portion of waveguide 205), EPE 324 is configured to expand the eyebox of the display represented by display light 218. For example, EPE 324 is configured to diffract display light 218 such that the exit pupil of display light 218 is enlarged (e.g., expanded). To expand the exit pupil of display light 218, EPE 324 includes, for example, one or more fanout gratings 330 that are configured to diffract or reflect received display light so as to increase the size of the exit pupil of the display light (e.g., expand the exit pupil of the light). Such fanout gratings 330, for example, include a set of grating structures (e.g., Bragg grating structures, surface-relief grating structures, polarization volume grating structures, volumetric holographic grating structures, mirrors, facets, mirror coatings) configured to diffract or reflect light based on one or more parameters (e.g., shape, angle, duty cycle, width, depth, fill factor) of fanout gratings 330. In embodiments, EPE 324 includes one or more transition grating areas having grating structures with parameters based on the parameters of fanout gratings 330. According to embodiments, EPE 324 provides display light 218 with the expanded exit pupil to at least a second portion of waveguide 205 configured to propagate display light 218 (e.g., via TIR, PIR) toward outcoupler 216. For example, fanout gratings 330 are configured to diffract or reflect received display light 218 such that the exit pupil of display light 218 is expanded and display light 218 is provided to outcoupler 216 via at least a second portion of waveguide 205. Outcoupler 216 is then configured to direct received display light 218 out of waveguide 205 and towards the eye 222 of a user. To this end, outcoupler 216 includes one or more outcoupler gratings 332 configured to diffract or reflect received display light 218 out of waveguide 205. Outcoupler gratings 332 includes, for example, a set of grating structures (e.g., Bragg grating structures, surface-relief grating structures, polarization volume grating structures, volumetric holographic grating structures) configured to diffract or reflect display light based on one or more parameters (e.g., shape, angle, duty cycle, width, depth, fill factor) of outcoupler gratings 332 such that the light is directed out of waveguide 205 and toward the eye 222 of a user.

To help assemble an HMD including waveguide 205, waveguide 205 includes one or more fiducial markers 334 formed on the surface of waveguide 205. Such fiducial markers 334, for example, are used to help align waveguide 205 with one or more other elements of an HMD during assembly. As an example, one or more fiducial markers 334 are used to help align waveguide 205 with one or more lens elements of an optical combiner. Though the example embodiment presented in FIG. 3 shows three fiducial markers 334-1, 334-2, 334-3 disposed on the surface of waveguide 205, in other embodiments, any number of fiducial markers 334 may be disposed on the surface of waveguide 205. In some embodiments, one or more fiducial markers 334 are configured to display an image or pattern when light is received at the fiducial marker 334. As an example, in embodiments, a fiducial marker 334 includes a recorded hologram that is visible when light is received at the fiducial marker 334. To this end, each fiducial marker 334 includes fiducial gratings 336. Fiducial gratings 336 include, for example, a set of grating structures (e.g., Bragg grating structures, surface-relief grating structures, polarization volume grating structures, volumetric holographic grating structures) configured to diffract or reflect display light based on one or more parameters (e.g., shape, angle, duty cycle, width, depth, fill factor) of fiducial gratings 336 such that a corresponding fiducial marker 334 displays an image or pattern (e.g., a recorded hologram).

Referring now to FIG. 4, a waveguide 205 including grating transition areas is presented. In embodiments, the waveguide 205 includes one or more incouplers 214, outcouplers 216, EPEs 324, fiducial markers 334, or any combination thereof. Within FIG. 4, an incoupler 214, outcoupler 216, EPE 324, or fiducial marker 334 included in waveguide 205 is represented as waveguide component 438. In embodiments, waveguide component 438 includes a set of grating structures performing the function of a corresponding incoupler 214, outcoupler 216, EPE 324, or fiducial marker 334 represented by waveguide component 438. That is to say, waveguide component 438 includes incoupler gratings 328, fanout gratings 330, outcoupler gratings 332, or fiducial gratings 336, respectively. Within the example embodiment presented by FIG. 4, the set of grating structures performing the function of a corresponding incoupler 214, outcoupler 216, EPE 324, or fiducial marker 334 represented by waveguide component 438 is represented as main grating area 440. According to embodiments, the waveguide component 438 further includes a first grating transition area 442 disposed on the surface of waveguide 205 adjacent to a first side 415 of main grating area 440 and a second grating transition area 444 disposed on the surface of waveguide 205 adjacent to second, opposing side 425 of main grating area 440. In some embodiments, the first transition grating area 442 has a length 446 between 100-400 nanometers, for example, running along a length of waveguide 205. Similarly, the second transition grating area 444 has a length 448 between 100-400 nanometers, for example, running along a length of waveguide 205. According to some embodiments, length 446 of the first grating transition area 442 is different from length 448 of the second grating transition area 444 while in other embodiments length 446 is equal to length 448.

In embodiments, main grating area 440 includes one or more grating structures (e.g., incoupler gratings 328, fanout gratings 330, outcoupler gratings 332, or fiducial gratings 336) each having one or more parameters at one or more respective values. As an example, main grating area 440 includes one or more grating structures each having a first angle, one or more grating structures each having a first depth, one or more grating structures each having a first width, or any combination thereof. According to embodiments, the first grating transition area 442 includes one or more grating structures having one or more parameters based on the parameters of the main grating area 440. For example, the first grating transition area 442 includes grating structures having modulated parameters such that each grating structure has respective values for the modulated parameters. Further, the first grating transition area 442 includes grating structures having modulated parameters such that a grating structure of the first grating transition area 442 farthest away from main grating area 440 has first values for the modulated parameters and the second grating structure closest to the main grating area 440 has second values for the modulated parameters. Additionally, each grating structure between the grating structure of the first grating transition area 442 farthest away from main grating area 440 and the second grating structure closest to the main grating area 440 includes values for the modulated parameters that approach the first values the closer the grating structure is to the first grating structure and approach the second values the closer the grating structure is to the second grating structure. In this way, the first grating transition area 442 provides a gradient for the values of the modulated parameters.

According to embodiments, the values of the modulated parameters for the grating structures of the first grating transition area 442 approach one or more of the values for the parameters of one or more grating structures in the main grating area 440. As an example, in some embodiments, the main grating area 440 includes one or more gratings structures having a first angle. Based on the main grating area 440, each grating structure of the first transition area 442 has a respective angle such that grating structures of the first grating transition area 442 closer to the main grating area 440 have an angle closer in value to the first angle of the grating structures in the main grating area 440. In this way, the values of the modulated parameters for the grating structures of the first grating transition area 442 approach the values of the parameters of grating structures in the main grating area 440 the closer the grating structure is to the main grating area 440. In some embodiments, the grating structure of the first grating transition area 442 closest to the main grating area 440 includes values for one or more modulated parameters that are closest to the values for the parameters for one or more grating structures in the main grating area 440, equal to the values for the parameters for one or more grating structures in the main grating area 440, or both. Due to the modulated parameters of the grating structures in the first grating transition area 442 approaching the values of the parameters of the grating structures in the main grating area 440 the closer the grating structure is to the main grating area 440, a master stamp representing the patterns of the first grating transition area 442 and the main grating area 440 (e.g., negatives of the patterns of the first grating transition area 442 and the main grating area 440) is less likely to damage a soft-working stamp during fabrication. That is to say, due to a master stamp representing a pattern that includes the first grating transition area 442, less stress is placed on a soft-working stamp as the soft-working stamp is removed from the master stamp. Because less stress is placed on the soft-working stamp, the soft-working stamp is less likely to be damaged by tearing, helping the soft-orking stamp to print the main grating area 440 so as to maintain the intended function of the main grating area 440. Additionally, a soft-working stamp representing a pattern that includes the first grating transition area 442 is less likely to introduce air bubbles in the set of gratings for the main grating area 440 formed by the soft-working stamp. Because fewer air bubbles are introduced into the set of gratings, the set of gratins is more likely to function as intended.

Further, in embodiments, the second grating transition area 444 includes one or more grating structures having one or more parameters based on the parameters of the main grating area 440, similar to the first grating transition area 442. For example, the second grating transition area 444 includes grating structures having modulated parameters such that a grating structure of the first grating transition area 442 farthest away from main grating area 440 has first values for the modulated parameters and the second grating structure closest to the main grating area 440 has second values for the modulated parameters. Further, each grating structure between the grating structure of the first grating transition area 442 farthest away from main grating area 440 and the second grating structure closest to the main grating area 440 includes values for the modulated parameters that approach the first values the closer the grating structure is to the first grating structure and approach the second values the closer the grating structure is to the second grating structure. In this way, the second grating transition area 444 provides a gradient for the values of the modulated parameters. As an example, the second grating transition area 444 provides a gradient having an opposite direction from the gradient provided by the first grating transition area 442. As such, the values of the modulated parameters for the grating structures of the second grating transition area 444 approach the values of the parameters of grating structures in the main grating area 440 the closer the grating structure is to the main grating area 440. As an example, the grating structure of the second grating transition area 444 closest to the main grating area 440 includes values for one or more modulated parameters that are closest to the values for the parameters for one or more grating structures in the main grating area 440, equal to the values for the parameters for one or more grating structures in the main grating area 440, or both. Because the modulated parameters of the grating structures in the second grating transition area 444 approach the values of the parameters of the grating structures in the main grating area 440 the closer the grating structure is to the main grating area 440, a master stamp representing the patterns of the second grating transition area 444 and the main grating area 440 is less likely to damage a soft-working stamp during fabrication. As the soft-working stamp is less likely to be damaged, the soft-working stamp is better able to print the main grating area 440 so as to maintain the intended function of the main grating area 440. Additionally, a soft-working stamp that includes a pattern representing the second grating transition area 444 is less likely to introduce air bubbles in the set of gratings for the main grating area 440 formed by the soft-working stamp, also helping to maintain the intended function of the main grating area 440.

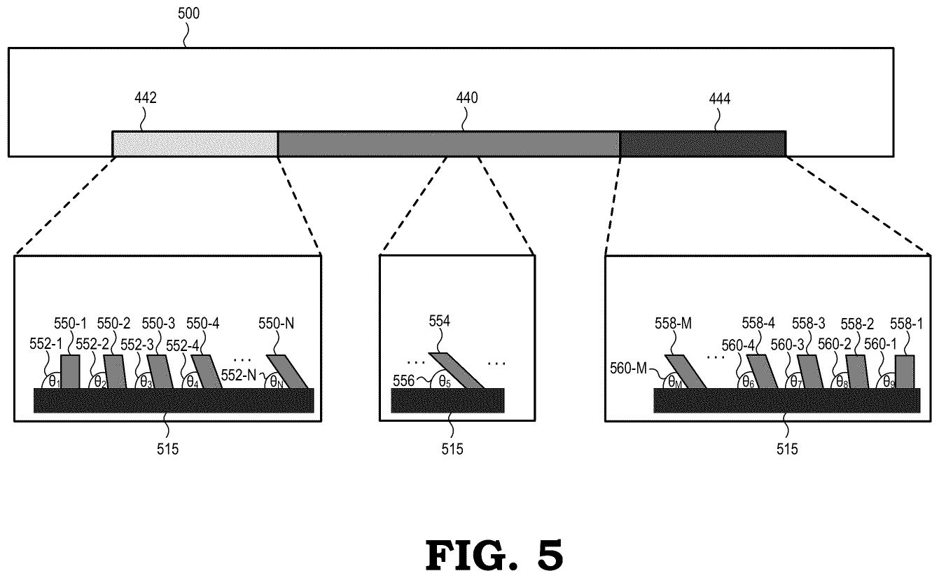

Referring now to FIG. 5, an example waveguide 500 including first and second grating transition areas having modualted angles is presented. In embodiments, example waveguide 500 is implemented in projection system 200 as waveguide 205. According to embodiments, example waveguide 500 includes a main grating area 440, a first grating transition area 442, and a second grating transition area 444. For example, waveguide 500 includes an incoupler 214, outcoupler 216, EPE 324, or fiducial marker 334 including a main grating area 440, a first grating transition area 442, and a second grating transition area 444. In embodiments, the main grating area 440 includes a grating structure 554 disposed on a surface 515 of example waveguide 500 that has a first parameter at a first value. For example, grating structure 554 has an angle θ₅ 556 (e.g., 45°) relative to the surface 515 of example waveguide 500. According to some embodiments, grating structure 554 is a center grating structure in the main grating area 440,

In embodiments, the first grating transition area 442 is disposed adjacent to a first side of the main grating area 440 and includes a number of grating structures 550 with one or more modulated parameters disposed on a surface 515 of example waveguide 500. As an example, the first grating transition area 442 includes a number of grating structures 550 with modulated angles 552 such that grating structures 550 closer to the main grating area 440 have angles 552 closer to angle θ₅ 556. To this end, the first grating transition area 442 includes a first grating structure 550-1 farthest from main grating area 440 that has a first angle θ₁ 552-1 (e.g., 90°) relative to the surface 515 of example waveguide 500 and a second grating structure 550-2 that has a second angle θ₂ 552-2 relative to the surface 515 of example waveguide 500 that is less than the first angle θ₁ 552-1. Further, the first grating transition area 442 includes a third grating structure 550-3 having a third angle θ₃ 552-3 relative to the surface 515 of the example waveguide 500 that is less than the second angle θ₂ 552-2 and the first grating transition area 442 includes a fourth grating structure 550-4 having a fourth angle θ₄ 552-4 relative to the surface 515 of the example waveguide 500 that is less than the third angle θ₃ 552-3. Additionally, the first grating transition area 442 includes a fifth grating structure 550-N that is disposed closest to the main grating area 440 and has a fifth angle 552-N θ_{N} that is less than the fourth angle θ₄ 552-4. In this way, the grating structures 550 of the first grating transition area 442 include of gradient of angles that starts with a first angle θ₁ 552-1 and ends with a fifth angle θ_{N} 552-N that is closest in value to the angle θ₅ 556 of the main grating area 440. Though the example embodiment presented in FIG. 5 shows the first grating transition area 442 as having five grating structures (550-1, 550-2, 550-3, 550-4, 550-N) representing an N number of grating structures, in other embodiments, the first grating transition area 442 can include any number of grating structures 550.

Additionally, according to embodiments, the second grating transition area 444 is disposed adjacent to a second side of the main grating area 440 and includes a number of grating structures 558 with one or more modulated parameters disposed on a surface 515 of example waveguide 500. For example, the second grating transition area 444 includes a number of grating structures 558 with modulated angles 560 such that grating structures 558 closer to the main grating area 440 have angles 560 closer to angle θ₅ 556. As an example, the second grating transition area 444 includes a first grating structure 558-1 farthest from the main grating area 440 that has a first angle θ₉ 560-1 (e.g., 90°) relative to the surface 515 of example waveguide 500 and a second grating structure 558-2 that has a second angle θ₈ 560-2 relative to the surface 515 of example waveguide 500 that is less than the first angle θ₉ 560-1. Additionally, the second grating transition area 444 includes a third grating structure 558-3 having a third angle θ₇ 560-3 relative to the surface 515 of the example waveguide 500 that is less than the second angle θ₈ 560-2 and a fourth grating 558-4 having a fourth angle θ₆ 560-4 relative to the surface 515 of the example waveguide 500 that is less than the third angle θ₇ 560-3. The second grating transition area 444 also includes a fifth grating structure 558-M that is disposed closest to the main grating area 440 and has a fifth angle θ_{M} 560-M that is less than the fourth angle θ₆ 560-4. As such, the grating structures 558 of the second grating transition area 444 include of gradient of angles that starts with a first angle θ₉ 560-1 and ends with a fifth angle θ_{M} 552-M that is closest in value to the angle θ₅ 556 of the main grating area 440. Though the example embodiment presented in FIG. 5 shows the second grating transition area 444 as having five grating structures (560-1, 560-2, 560-3, 560-4, 560-M) representing an M number of grating structures, in other embodiments, the second grating transition area 444 can include any number of grating structures 560.

In some embodiments, the first grating transition area 442 has a number of grating structures 550 equal to the number of grating structures 558 in the second grating transition area 444 while in other embodiments the first grating transition area 442 has a number of grating structures 550 different from the number of grating structures 558 in the second grating transition area 444. Additionally, according to some embodiments, the grating structure 550-1 of the first grating transition area 442 farthest from the main grating area 440 has an angle θ₁ 552-1 equal to the angle θ₉ 560-1 of the grating structure 558-1 of the second grating transition area 444 farthest away from the main grating area 440 while in other embodiments, the grating structure 550-1 of the first grating transition area 442 farthest from the main grating area 440 has a different angle. Further, in some embodiments, the grating structure 550-N of the first grating transition area 442 closest to the main grating area 440 has an angle θ_{N} 552-N equal to the angle θ_{M} 560-M of the grating structure 558-M of the second grating transition area 444 closest to the main grating area 440 while in other embodiments, the grating structure 550-N of the first grating transition area 442 closest to the main grating area 440 has a different angle.

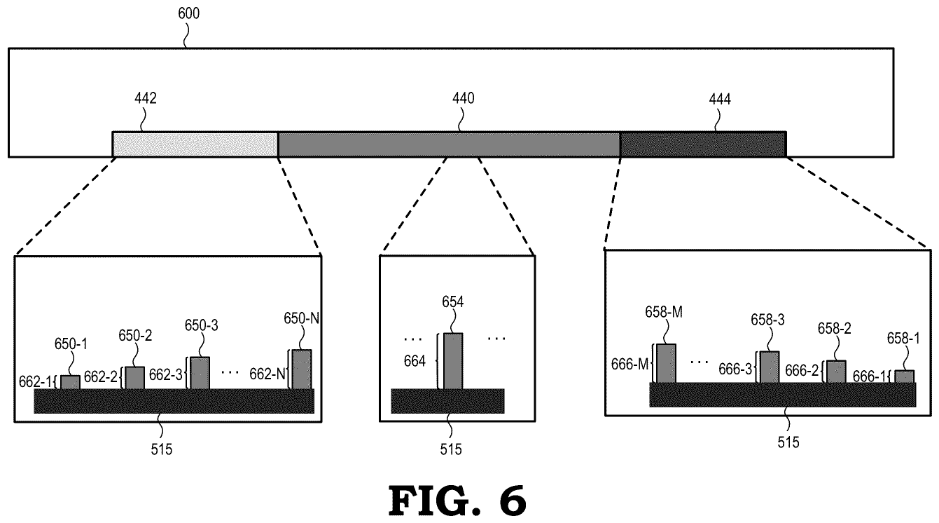

Referring now to FIG. 6, an example waveguide 600 including first and second grating transition areas with modulated depths is presented. In embodiments, example waveguide 600 is implemented in projection system 200 as waveguide 205. According to embodiments, example waveguide 600 includes a main grating area 440, a first grating transition area 442, and a second grating transition area 444. For example, waveguide 600 includes an incoupler 214, outcoupler 216, EPE 324, or fiducial marker 224 including a main grating area 440, a first grating transition area 442, and a second grating transition area 444. In embodiments, the main grating area 440 includes a grating structure 654 disposed on a surface 515 of example waveguide 600 that has a first parameter at a first value. For example, grating structure 654 has a depth (e.g., height) 664. In some embodiments, grating structure 654 is a center grating structure in the main grating area 440.

According to embodiments, the first grating transition area 442 is disposed adjacent to a first side of the main grating area 440 and includes a number of grating structures 650 with one or more modulated parameters disposed on a surface 515 of example waveguide 600. As an example, the first grating transition area 442 includes a number of grating structures 650 with modulated depths (e.g., heights) 662 such that grating structures 650 closer to the main grating area 440 have depths 662 closer to depth 664. For example, the first grating transition area 442 includes a first grating structure 650-1 farthest from main grating area 440 that has a first depth 662-1 and a second grating structure 650-2 that has a second depth 662-2 that is greater than the first depth 662-1. Also, the first grating transition area 442 includes a third grating structure 650-3 having a third depth 662-3 that is greater than the second depth 662-2. Additionally, the first grating transition area 442 includes a fourth grating structure 650-N that is disposed closest to the main grating area 440 and has a fourth depth 662-N that is greater than the depth 662-3. As such, the grating structures 650 of the first grating transition area 442 include of gradient of depths (e.g., heights) that starts with a first depth 662-1 and ends with a fourth depth 662-N that is closest in value to the depth 662 of the main grating area 440. Though the example embodiment presented in FIG. 6 shows the first grating transition area 442 as having four grating structures (650-1, 650-2, 650-3, 650-N) representing an N number of grating structures, in other embodiments, the first grating transition area 442 can include any number of grating structures 650.

Further, the second grating transition area 444 is disposed adjacent to a second side of the main grating area 440 and includes a number of grating structures 658 with one or more modulated parameters disposed on a surface 515 of example waveguide 500. For example, the second grating transition area 444 includes a number of grating structures 658 with modulated depths (e.g., heights) 666 such that grating structures 658 closer to the main grating area 440 have depths 666 closer to depth 664. As an example, the second grating transition area 444 includes a first grating structure 560-1 farthest from the main grating area 440 that has a first depth 666-1 and a second grating structure 658-2 that has a second depth 666-2 that is greater than the first depth 666-1. Further, the second grating transition area 444 includes a third grating structure 658-3 having a third depth 666-3 that is less than the second angle depth 666-2. The second grating transition area 444 also includes a fourth grating structure 560-M that is disposed closest to the main grating area 440 and has a fourth depth 666-M that is greater than the third depth 666-3. In this way, the grating structures 658 of the second grating transition area 444 include of gradient of depths (e.g., heights) that starts with a first depth 666-1 and ends with a fourth depth 666-M that is closest in value to the depth 664 of the main grating area 440. Though the example embodiment presented in FIG. 6 shows the second grating transition area 444 as having four grating structures (658-1, 658-2, 658-3, 658-4, 658-M) representing an M number of grating structures, in other embodiments, the second grating transition area 444 can include any number of grating structures 658.

According to embodiments, the first grating transition area 442 has a number of grating structures 650 equal to the number of grating structures 658 in the second grating transition area 444 while in other embodiments the first grating transition area 442 has a number of grating structures 650 different from the number of grating structures 658 in the second grating transition area 444. Additionally, according to some embodiments, the grating structure 650-1 of the first grating transition area 442 farthest from the main grating area 440 has a depth 662-1 equal to the depth 666-1 of the grating structure 658-1 of the second grating transition area 444 farthest away from the main grating area 440 while in other embodiments, the grating structure 650-1 of the first grating transition area 442 farthest from the main grating area 440 has a different depth. Further, in some embodiments, the grating structure 650-N of the first grating transition area 442 closest to the main grating area 440 has a depth 662-N equal to the depth 666-M of the grating structure 658-M of the second grating transition area 444 closest to the main grating area 440 while in other embodiments, the grating structure 650-N of the first grating transition area 442 closest to the main grating area 440 has a different depth.

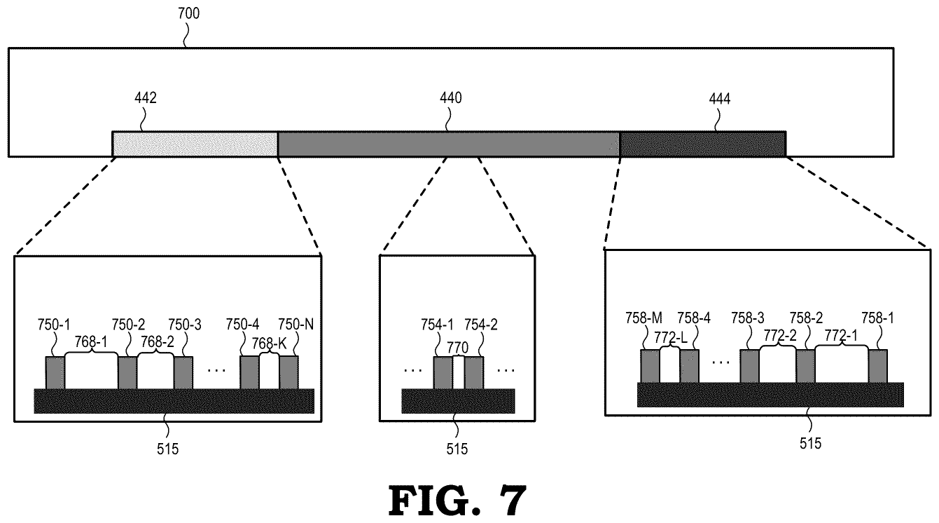

Referring now to FIG. 7, an example waveguide 700 including first and second grating transition areas with modulated duty cycles is presented. In embodiments, example waveguide 700 is implemented in projection system 200 as waveguide 205. According to embodiments, example waveguide 700 includes a main grating area 440, a first grating transition area 442, and a second grating transition area 444. For example, waveguide 600 includes an incoupler 214, outcoupler 216, EPE 324, or fiducial marker 224 including a main grating area 440, a first grating transition area 442, and a second grating transition area 444. In embodiments, the main grating area 440 includes grating structures 754-1 and 754-2 disposed on a surface 515 of example waveguide 600 that have a first parameter at a first value. For example, grating structures 754-1 and 754-2 have a duty cycle defined by the space 770 between grating structures 754-1 and 754-2.

In embodiments, the first grating transition area 442 is disposed adjacent to a first side of the main grating area 440 and includes a number of grating structures 750 with one or more modulated parameters disposed on a surface 515 of example waveguide 600. As an example, the first grating transition area 442 includes a number of grating structures 750 with modulated duty cycles defined by spaces 768 between the grating structures 750. For example, the first grating transition area 442 includes a first space 768-1 between a first grating structure 750-1 farthest from the main grating area 440 and a second grating structure 750-2. Further, the first grating transition area 442 includes a second space 768-2 between the second grating structure 750-2 and a third grating structure 750-3 with the second space 768-2 being smaller than the first space 768-1. Additionally, the first grating transition area 442 includes a third space 768-K between a fourth grating structure 750-4 and a fifth grating structure 750-N that is disposed closest to the main grating area 440 wherein the third space 768-K is less than the second space 768-2. In this way, the grating structures 750 of the first grating transition area 442 include a gradient of duty cycles as defined by the spaces 768 that starts with a first duty cycle defined by the first space 768-1 and ends with a third duty cycle defined by the third space 768-K that is closest in value to the duty cycle of the main grating area 440 defined by space 770. Though the example embodiment presented in FIG. 7 shows the first grating transition area 442 as having five grating structures (750-1, 750-2, 750-3, 750-4, 750-N) representing an N number of grating structures and defining three spaces (e.g., 768-1, 768-2, 768-K) representing a K number of spaces, in other embodiments, the first grating transition area 442 can include any number of grating structures 750 defining any number of spaces 768.

According to embodiments, the first grating transition area 442 has a number of grating structures 750 equal to the number of grating structures 758 in the second grating transition area 444 while in other embodiments the first grating transition area 442 has a number of grating structures 750 different from the number of grating structures 758 in the second grating transition area 444. Additionally, according to some embodiments, the space 768-1 of the first grating transition area 442 is equal to the space 772-1 of the second grating transition area 444 while in other embodiments, the space 768-1 is different from the space 772-1. Further, in some embodiments, the space 768-K of the first grating transition area 442 is equal to the space 772-L of the second grating transition area 444 while in other embodiments, the space 768-K is different from the space 772-L.

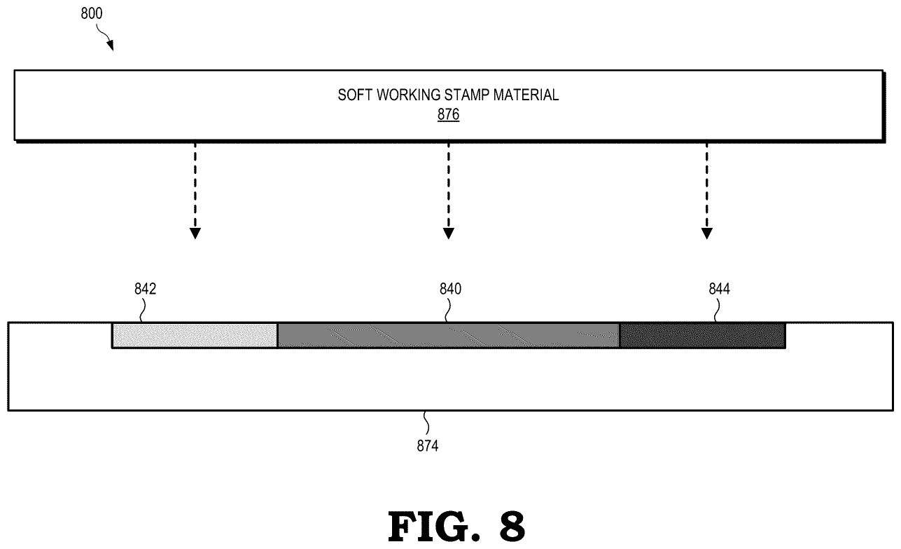

Referring now to FIG. 8, an example process 800 for fabricating a soft-working stamp is presented. In embodiments, example process 800 first includes a master stamp 874. Master stamp 874, for example, is formed from a first material (e.g., silicon) and includes a first transition pattern 842, a main pattern 840, and a second transition pattern 844. According to embodiments, master stamp 874 includes a main pattern 840 representative of a set of the grating structures of a main grating area 440 that forms an incoupler 214, outcoupler 216, EPE 324, or fiducial marker 334 of a waveguide 205. As an example, the main pattern 840 includes a pattern represented on a surface of master stamp 874 that represents a negative of the grating structures of a main grating area 440. The first transition pattern 842 is disposed adjacent to a first side of the main pattern 840 and is representative of the grating structures of a first grating transition area 442. That is to say, the first transition pattern 842 is representative of two or more grating structures of a first grating transition area 442. For example, the first transition pattern 842 is representative of a set of grating structures having one or more modulated parameters such that grating structures closer to a main grating area 440 have parameters closer in value to parameters of the main grating area 440. As an example, the first transition pattern 842 includes a pattern represented on a surface of master stamp 874 that represents a negative of the grating structures of a first grating transition area 442. Additionally, in embodiments, the second transition pattern 844 is disposed adjacent to a second, opposite side of the main pattern 840 and is representative of the grating structures of a second grating transition area 444. As an example, the second transition pattern 844 is representative of a set of grating structures having one or more modulated parameters such that grating structures closer to a main grating area 440 have parameters closer in value to parameters of the main grating area 440. For example, in some embodiments, the second transition pattern 844 includes a pattern represented on a surface of master stamp 874 that represents a negative of the grating structures of a second grating transition area 444.

According to embodiments, example process 800 includes a soft-working stamp material 876 being deposited on the surface of the master stamp 874 such that the soft-working stamp material 876 covers the first transition pattern 842, the main pattern 840, and the second transition pattern 844. The soft-working stamp material 876, for example, includes an elastomeric polymer. After the soft-working stamp material 876 is deposited on the surface of master stamp 874, the soft-working stamp material 876 is pressed into the first transition pattern 842, the main pattern 840, and the second transition pattern 844 by, for example, a glass or plastic substrate (not pictured for clarity). The soft-working stamp material 876 is then cured and removed from the master stamp 874 to form a soft-working stamp. Due to the first transition pattern 842 and the second transition pattern 844, less stress is placed on the soft working stamp material 876 as it is removed from the master stamp 874 than if the first transition pattern 842 and the second transition pattern 844 were not present on the master stamp. Because less stress is placed on the soft-working stamp material 876 when it is removed, the soft-working stamp material 876 is less likely to be damaged, helping to form an undamaged soft-working stamp.

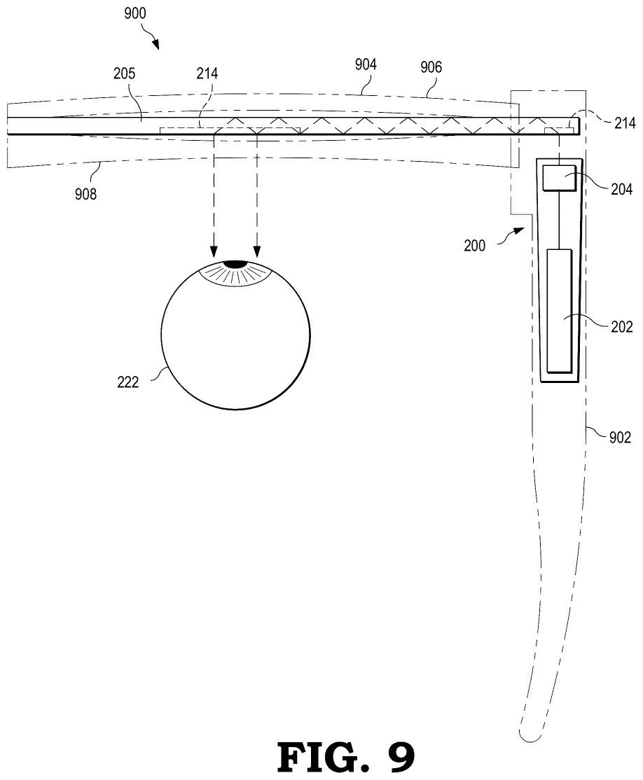

FIG. 9 illustrates a portion of an HMD 900 that includes a waveguide with one or more grating transition areas. For example, according to embodiments, HMD 900 includes one or more waveguides 205 each having a first grating transition area 442, a second grating transition area 444, or both. In some embodiments, the HMD 900 represents the display system 100 of FIG. 1. The optical engine 202, optical scanner 204, and a portion of the waveguide 205 with incoupler 214 are included in an arm 902 of the HMD 900, in the present example.

The HMD 900 includes an optical combiner lens 904 which includes a first lens 906, a second lens 908, and the waveguide 205, with the waveguide 205 disposed between the first lens 906 and the second lens 908. Display light 218 exiting through the outcoupler 216 travels through the second lens 908 (which corresponds to, for example, the lens element 110 of the display system 100). In use, the light exiting second lens 908 enters the pupil of an eye 222 of a user wearing the HMD 900, causing the user to perceive a displayed image carried by the display light 218 output by one or more optical engines 202.

According to embodiments, the optical combiner lens 904 is substantially transparent, such that light from real-world scenes corresponding to the environment around the HMD 900 passes through the first lens 906, the second lens 908, and the waveguide 205 to the eye 222 of the user. In this way, images, or other graphical content output by the projection system 200 are combined (e.g., overlayed) with real-world images of the user's environment when projected onto the eye 222 of the user to provide an AR experience to the user.

Although not shown in the depicted example, in some embodiments additional optical elements are included in any of the optical paths between the optical engines 202 and the incoupler 214, in between the incoupler 214 and the outcoupler 216, in between the outcoupler 216 and the eye 222 of the user (e.g., in order to shape the display light for viewing by the eye 222 of the user), or any combination thereof. As an example, a prism is used to steer light from the optical scanner 204 into the incoupler 214 so that light is coupled into incoupler 214 at the appropriate angle to encourage propagation of the light in waveguide 205 by TIR. Also, in some embodiments, one or more exit pupil expanders (e.g., the EPE 324) including, for example, fanout gratings 330 are arranged in an intermediate stage between incoupler 214 and outcoupler 216 to receive light that is coupled into waveguide 205 by the incoupler 214, expand the light, and redirect the light towards the outcoupler 216 where the outcoupler 216 then couples the display light out of the waveguide 205 (e.g., toward the eye 222 of the user).

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design shown herein, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A waveguide, comprising:
a set of grating structures disposed on a surface of the waveguide and configured to direct light based on a first parameter of one or more grating structures of the set of grating structures; and
a first transition area disposed adjacent to a first side of the set of grating structures, wherein the first parameter is modulated across the first transition area.

2. The waveguide of claim 1, wherein:
the one or more grating structures of the set of grating structures have a first value for the first parameter; and
the first transition area includes a grating structure disposed on the surface of the waveguide having a second value for the first parameter, wherein the first value is different from the second value.

3. The waveguide of claim 2, wherein:
the first transition area includes a second grating structure disposed on the surface of the waveguide having a third value for the first parameter, wherein the third value is between the first value and the second value.

4. The waveguide of claim 1, further comprising:
a second transition area disposed adjacent to a second side of the set of grating structures, wherein the first parameter is modulated across the second transition area.

5. The waveguide of claim 1, wherein the parameter comprises an angle.

6. The waveguide of claim 1, wherein the parameter comprises a depth.

7. The waveguide of claim 1, wherein the set of grating structures forms at least one of an incoupler, outcoupler, exit pupil expander, or a fiducial marker.

8. The waveguide of claim 1, wherein the first transition area has a length between 100-400 nanometers.

9. A head-worn display (HWD), comprising:
an optical engine; and
a waveguide comprising:
a set of grating structures disposed on a surface of the waveguide and configured to direct light from the optical engine based on a first parameter of one or more grating structures of the set of grating structures; and
a first transition area disposed adjacent to a first side of the set of grating structures, wherein the first parameter is modulated across the first transition area.

10. The HWD of claim 9, wherein:
the one or more grating structures of the set of grating structures have a first value for the first parameter; and
the first transition area includes a grating structure disposed on the surface of the waveguide having a second value for the first parameter, wherein the first value is different from the second value.

11. The HWD of claim 10, wherein:
the first transition area includes a second grating structure disposed on the surface of the waveguide having a third value for the first parameter, wherein the third value is different from the first value and the second value.

12. The HWD of claim 9, wherein the waveguide further comprises:
a second transition area disposed adjacent to a second side of the set of grating structures, wherein the first parameter is modulated across the second transition area.

13. The HWD of claim 9, wherein the parameter comprises a duty cycle.

14. The HWD of claim 9, wherein the parameter comprises a depth.

15. The HWD of claim 9, wherein the set of grating structures forms at least one of an incoupler, outcoupler, exit pupil expander, or a fiducial marker.

16. The HWD of claim 9, wherein the first transition area has a length between 100-400 nanometers.

17. A method, comprising:
depositing a soft working stamp material on a master stamp, wherein the master stamp includes:
a main pattern representative of a set of grating structures to be disposed on a surface of a waveguide such that the set of grating structures is configured to direct light based on a first parameter of one or more grating structures of the set of grating structures; and
a first transition pattern disposed adjacent to a first side of the main pattern, wherein the first transition pattern is representative of two or more grating structures to be disposed on the surface of the waveguide such that the first parameter is modulated across the two or more grating structures; and
removing the soft working stamp material from the master stamp.

18. The method of claim 17, wherein the master stamp further includes a second transition pattern disposed adjacent to a second side of the main pattern, wherein the second transition pattern is representative of two or more other grating structures to be disposed on the surface of the waveguide such that the first parameter is modulated across the two or more other grating structures.

19. The method of claim 17, wherein the first parameter is an angle.

20. The method of claim 17, wherein the first parameter is a depth.
